(19) United States
(12) Patent Application Publication
(10) Pub. No.: US 2016/0347576 A1
(43) Pub. Date: Dec. 1, 2016

(54) CABLE MACHINE FOR SUPERCONDUCTING TAPES OR WIRES

(71) Applicant: Advanced Conductor Technologies LLC, Boulder, CO (US)

(72) Inventors: Daniel Cornelis van der Laan, Longmont, CO (US); Anne Freerk de Jager, Enschede (NL)

(73) Assignee: Advanced Conductor Technologies LLC, Boulder, CO (US)

(21) Appl. No.: 15/167,909

(22) Filed: May 27, 2016

Related U.S. Application Data
(60) Provisional application No. 62/167,221, filed on May 27, 2015.

(51) Int. Cl. B65H 81/08; H01B 13/02; H01B 13/00

(52) U.S. Cl. CPC B65H 81/08; H01B 13/0003; H01B 13/02

(57) ABSTRACT

A cable machine system for winding conductive tapes or wires around a cable core includes a rotatable pickup spool for receiving and winding a cable. The system also includes a rotatable shaft having a central passage along its axial length, through which the cable core extends during a winding operation. At least one rotatable conductor spool is rotatable about a spool axis and holds a conductive tape or wire. Each rotatable conductor spool is attached to the rotatable shaft and rotatable about the axis of the rotatable shaft with rotation of the rotatable shaft. A tape or wire extends from each conductor spool to the cable core and is wound around the cable core as the rotatable shaft is rotated about its axis.

### CROSS-REFERENCE TO RELATED APPLICATIONS AND CLAIM OF PRIORITY

This application claims priority from U.S. Provisional Application No. 62/167,221, filed on May 27, 2015, incorporated herein by reference in its entirety.

### TECHNICAL FIELD

This invention was made with government support under contract number DEAI05-98OR22652 sponsored by the Department of Energy, Office of High Energy Physics. The government has certain rights in the invention.

### BACKGROUND

A cable machine may be used to wind superconducting tapes or wires on a superconducting cable. Some applications require fragile and expensive tapes or wires to be bundled onto long cables, without any significant damage occurring to the tapes or wires. Such cables, for example Conductor On Round Core (CORC) cables wound from superconducting tapes, require the use of a machine to allow for long cable lengths and high cabling quality. Fine control of the tension of each tape, as well as the spacing between tapes, is required during the winding process. In some cases, the tapes or wires are elastic or springy and wound on a relatively small former. Therefore, it can be beneficial to maintain the tension on the tapes or wires during the cabling process, even when the cable machine is stopped or paused in either a controlled manner or during an uncontrolled manner (e.g., a power failure or other fault). The loss of tape tension, especially in cables that have a tight bending diameter, such as CORC cables, can result in a partial release of the tape or wire from the cable due to the elastic or springy nature of the tape or wire. This may result in the removal of all tapes or wires from the affected layer. Removal of the tapes or wires from the cable may likely result in the total loss of the tapes or wires, and thus a high expense. A cable machine able to maintain tension of the tapes or wires during all circumstances during the cabling process can, thus, be beneficial. Further, a cable machine able to maintain an accurate tension and provide gap spacing control can be beneficial.

### SUMMARY OF THE DISCLOSURE

Embodiments described herein relate to a cable machine system for winding conductive tapes or wires around a cable core, where the cable machine system includes a rotatable pickup spool for receiving and winding a cable. The system also includes a rotatable shaft having a central passage along its axial length, through which the cable core extends during a winding operation. At least one rotatable conductor spool is rotatable about a spool axis and holds a conductive tape or wire. Each rotatable conductor spool is attached to the rotatable shaft and rotatable about the axis of the rotatable shaft with rotation of the rotatable shaft. A tape or wire extends from each conductor spool to the cable core and is wound around the cable core as the rotatable shaft is rotated about its axis.

In a cable machine system according to further embodiments, the at least one spool for holding a conductive tape or wire comprises a plurality of spools, each spool being attached to the rotatable shaft and rotatable about the axis of the rotatable shaft with rotation of the rotatable shaft.

A cable machine system according to further embodiments includes a plurality of adjustable holders, each adjustable holder for holding a respective one of the at least one conductor spool at an angle that is adjustable. The angle of the respective one of the conductor spools defines an angle at which the conductive tape or wire meets the cable core, upon the respective one of the conductor spools holding a conductive tape or wire and upon the tape or wire extending from the conductor spool to the cable core.

A cable machine system according to further embodiments includes a drive device for driving the at least one pickup spool to move the cable core through the central passage of the rotatable shaft, as the rotatable shaft is rotated.

A cable machine system according to further embodiments includes at least one sensor for sensing a speed at which the cable core is moved through the central passage of the rotatable shaft.

A cable machine system according to further embodiments includes a controller operatively coupled to the at least one sensor, for controlling a speed of rotation of the rotatable shaft, based at least in part on the speed sensed by the at least one sensor.

A cable machine system according to further embodiments includes a drive device for driving the rotatable shaft for rotation about the axis of the rotatable shaft, and at least one sensor for sensing a speed at which the cable core is moved through the central passage of the rotatable shaft. A controller may be operatively coupled to the at least one sensor and the drive device, for controlling a speed of rotation of the rotatable shaft, based at least in part on the speed sensed by the at least one sensor.

A cable machine system according to further embodiments includes a drive device for driving the at least one conductor spool about the axis of rotation of the conductor spool, and at least one sensor for sensing a speed at which the cable core is moved through the central passage of the rotatable shaft. A controller may be operatively coupled to the at least one sensor and the drive device, for controlling a speed of rotation of the conductor spool, based at least in part on the speed sensed by the at least one sensor.

A cable machine system according to further embodiments includes an adjustable holder for holding the at least one conductor spool at an angle that is adjustable. The angle of the at least one conductor spool defining an angle at which the conductive tape or wire meets the cable core, upon the conductor spool holding a conductive tape or wire and upon the tape or wire extending from the conductor spool to the cable core.

A cable machine according to further embodiments includes a drive device for driving the at least one conductor spool about the axis of rotation of the conductor spool in a first direction of rotation corresponding to a direction to dispense conductive tape or wire from the conductor spool. A rotation lock may be provided for inhibiting rotation of the conductor spool in a direction opposite to the first direction.

A cable machine system according to further embodiments includes a rotatable takeoff spool for supplying the cable core, a drive device for driving the takeoff spool for rotation about an axis of the takeoff spool, and a cable tension spring operatively coupled to the takeoff spool and configured to provide a force on the takeoff spool in a direction away from the pickup spool.

A cable machine system according to further embodiments includes a frame to which the pickup spool, the takeoff spool and the rotatable shaft are each supported for rotation.

Further embodiments relate to a method of operating a cable machine system for winding conductive tapes or wires around a cable core. Such method embodiments include providing a rotatable pickup spool on which a cable may be wound, and supporting a rotatable shaft for rotation about an axis extending in the axial length of the rotatable shaft. Such method embodiments further include extending the cable through a central passage in a rotatable shaft, along the axial length of the rotatable shaft, and to the pickup spool, and holding at least one conductive tape or wire on at least one conductor spool having an axis of rotation, each conductor spool being attached to the rotatable shaft. Such method embodiments further include

rotating each conductor spool about the axis of the rotatable shaft with rotation of the rotatable shaft, while the cable extends through the central passage in the rotatable shaft, and moving the cable core through the central passage of the rotatable shaft while rotating the rotatable shaft about the axis of the axis of the rotatable shaft and while the tape or wire is extended from the conductor spool to the cable core, to wind the tape or wire around the cable core.

A method according to further embodiments includes holding at least one conductive tape or wire comprises holding a plurality of conductive tapes or wires on a plurality of respective conductor spools, each conductor spool being attached to the rotatable shaft.

A method according to further embodiments includes a plurality of adjustable holder, each adjustable holder for holding a respective one of the at least one conductor spool at an angle that is adjustable, the angle of the respective one of the conductor spools defining an angle at which the conductive tape or wire meets the cable core, upon the respective one of the conductor spools holding a conductive tape or wire and upon the tape or wire extending from the conductor spool to the cable core.

A method according to further embodiments includes driving the at least one pickup spool to move the cable core through the central passage of the rotatable shaft, as the rotatable shaft is rotated.

A method according to further embodiments includes sensing, with a sensor, a speed at which the cable core is moved through the central passage of the rotatable shaft; and controlling a speed of rotation of the rotatable shaft, based at least in part on the speed sensed by the at least one sensor.

A method according to further embodiments includes driving the rotatable shaft for rotation about the axis of the rotatable shaft, sensing, with a sensor, a speed at which the cable core is moved through the central passage of the rotatable shaft, and controlling a speed of rotation of the rotatable shaft, based at least in part on the speed sensed by the at least one sensor.

A method according to further embodiments includes driving the at least one conductor spool about the axis of rotation of the conductor spool, sensing, with a sensor, a speed at which the cable core is moved through the central passage of the rotatable shaft, and controlling a speed of rotation of the conductor spool, based at least in part on the speed sensed by the at least one sensor.

Further embodiments relate to methods of making a cable machine system for winding conductive tapes or wires around a cable core. Such further embodiments include supporting a pickup spool for rotation, for receiving and winding a cable, and supporting a rotatable shaft for rotation about an axis extending along an axial length of the rotatable shaft, the rotatable shaft having a central passage along the axial length, through which the cable core may extend during a winding operation. Such methods further include supporting at least one conductor spool for rotation about the axis of rotation of the conductor spool, the conductor spool for holding a conductive tape or wire, each conductor spool being attached to the rotatable shaft. Upon the at least one conductor spool holding a conductive tape or wire and upon a cable core moving through the central passage of the rotatable shaft, the tape or wire may be extended from the conductor spool to the cable core and be wound around the cable core as the rotatable shaft is rotated about its axis.

### BRIEF DESCRIPTION OF THE DRAWINGS

FIG. 1 is a perspective view of a cable machine configured to wind tapes or wires onto a cable with precision, according to an exemplary embodiment.

FIG. 2 is a perspective view of a cable pickup spool of the cable machine, according to an exemplary embodiment.

FIG. 3 is a close-up view of the motor and gears of the cable pickup spool, according to an exemplary embodiment.

FIG. 4 is a perspective view of a cable takeoff spool of the cable machine, mounted in a spring-loaded carriage, according to an exemplary embodiment.

FIG. 5 is a perspective view of a planetary drive of the cable machine with multiple tape spool holders mounted to it, according to an exemplary embodiment.

FIG. 6 is a detailed view of the assembly of the planetary drive, according to an exemplary embodiment.

FIG. 7 illustrates a configuration of the planetary drive with three tape spool holders mounted to the planetary drive shaft, according to an exemplary embodiment.

FIG. 8 is a detailed view of an individual tape spool holder that may be mounted to the planetary drive shaft, according to an exemplary embodiment.

FIG. 9 illustrates a CORC cable wound with the cable machine of the present disclosure, according to an exemplary embodiment.

FIGS. 10-12 illustrate an adjustment in position of a tape spool holder in order to adjust the winding angle of the tapes or wires, according to an exemplary embodiment.

FIG. 13 is a flow chart of a process for adjusting the motor speed of the cable takeoff spool of the cable machine, according to an exemplary embodiment.

FIG. 14 is a flow chart of a process for adjusting the rotational speed of the planetary drive shaft of the cable machine, according to an exemplary embodiment.

### DETAILED DESCRIPTION

Referring generally to the figures, a cable machine for superconducting tapes or wires is shown and described. The cable machine winds tapes or wires (such as, but not limited to fragile tapes or wires) around a cable with precise control of the tape or wire tension, cable tension, and the gap spacing between the tapes or wires in each layer of the winding. In particular examples, the cable machine is able to maintain the cable and tape or wire tension, even when a power outage or other failure occurs. The tension may be maintained with one or more (or a combination of) spring-loaded tensioners and self-locking worm gears.

According to exemplary embodiments, a cable machine includes a planetary drive that causes the tape or wire spools to rotate around the cable axis. The rotation of the tape or wire spools is driven and controlled by an electronic feedback system. In one embodiment, the rotational speed is a function of the actual cable speed measured by one or more sensors. In another embodiment, the rotational speed of the planetary drive is measured and used to determine the cable speed. The tension of the tapes or wires is driven by the cable speed in combination with the rotation of the planetary drive (e.g., by controlling the cable speed and rotational speed, the cable machine may control the tension of the tapes or wires).

According to exemplary embodiments, the tape or wire tension is determined from a tension arm displacement (i.e., a displacement of the tape or wire spool compared to a base position) that causes the tape or wire to be rotated around the cable at a different angle, and controlled through a feedback loop that powers the motors that drives the unspooling of the tapes or wires. Each motor of the cable machine (e.g., the motor for each tape or wire spool) is controlled by a dedicated electronic control system, which does not require communication with an external computer or other device during operation. In some examples, communication with an external computer may occur only when set points or parameters are set or changed by an external computer, or for transmitting sensor signals to the external computer for monitoring the sensor signals. Wireless communication between the external computer and the electronic control systems located on the tape or wire spools can prevent a need for electronic data transfer through a slip ring.

It should be noted that in the present disclosure, “tape” and “wire” may be used interchangeably to describe the material being wound by the cable machine.

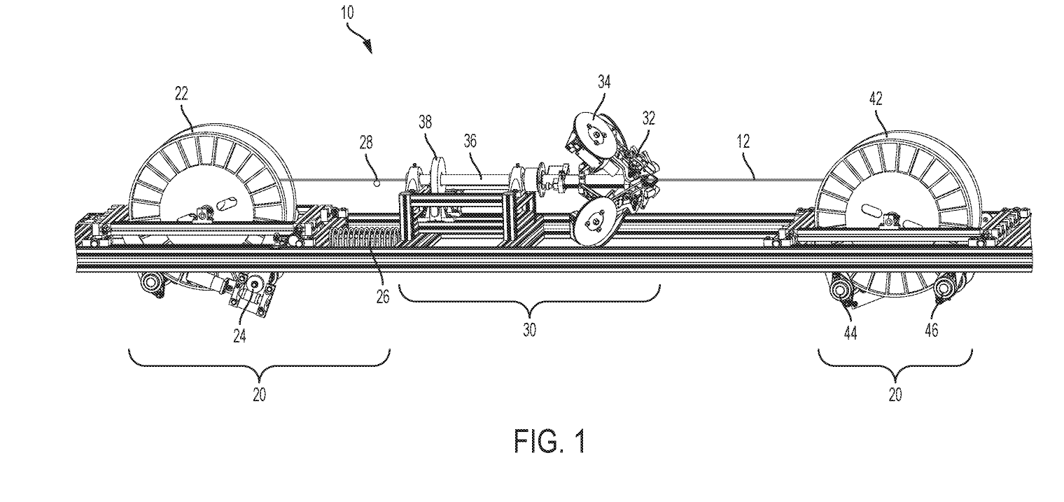

Referring to FIG. 1, a perspective view of a cable machine 10 according to an exemplary embodiment is shown. The cable machine 10 generally receives one or more tapes or wires and rotates the tapes or wires around a core or former 11 to form a cable 12. In further embodiments, the tapes or wires are rotated around a previously wound cable (where reference number 11 represents a former with one or more layers of tapes or wires wound thereon) to form a multi-layer cable 12 (having multiple layers of tapes or wires wound around a former). The cable 12 may be a superconducting cable, such as, but not limited to, a CORC. In other embodiments, the cable 12 may be another type of superconductive or normally conductive cable having one or more layers of superconducting tapes or wires and/or one or more layers of non-superconducting, conductive tapes or wires. In particular embodiments, multiple superconducting tape conductors (e.g., the tapes or wires as described in the present disclosure) are wound around the former in at least one layer. The former may be of a relatively small diameter, allowing the cable 12 to be compact. The former may be made of a flexible material (e.g., copper or other metals, polymers, rubbers, ceramics, etc.) to allow the cable 12 to bend or flex to a predefined extent without being damaged. Alternatively, the former may be made of a more rigid material for use in suitable environments, may be of a solid or combination of solid and hollow portions, etc. The superconducting tape conductors may include one or more superconducting layers made of a superconducting material that provides superconductivity in an expected operational environment of the cable 12. The tape conductors may be composed of any suitable superconducting tape, including, but not limited to YBa2Cu3O7-δ (YBCO) tape conductors, Bi2Sr2Ca2Cu3Ox (Bi-2223) tape conductors, GdBa2Cu3O7-δ (GBCO) tape conductors, YBCO or GBCO coated tape conductors manufactured by SuperPower Inc. (Schenectady, N.Y.), RE-Ba2Ca3O7-□ (REBCO) (RE=rare earth) coated tape conductors, or other suitable superconducting tape conductor. The tape conductors are would around the former in a helical fashion. The superconducting tape conductors may include a substrate (such as, but not limited to a metal substrate) and a superconducting film that is supported on one side of the metal substrate, with one or more resistive barrier layers between the superconducting film and the substrate.

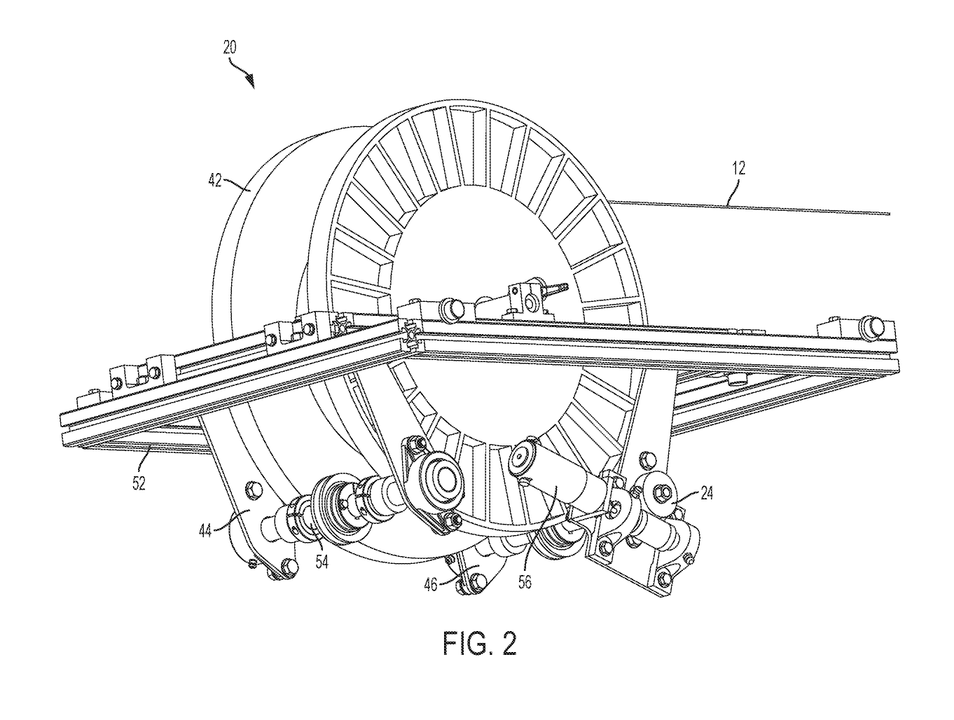

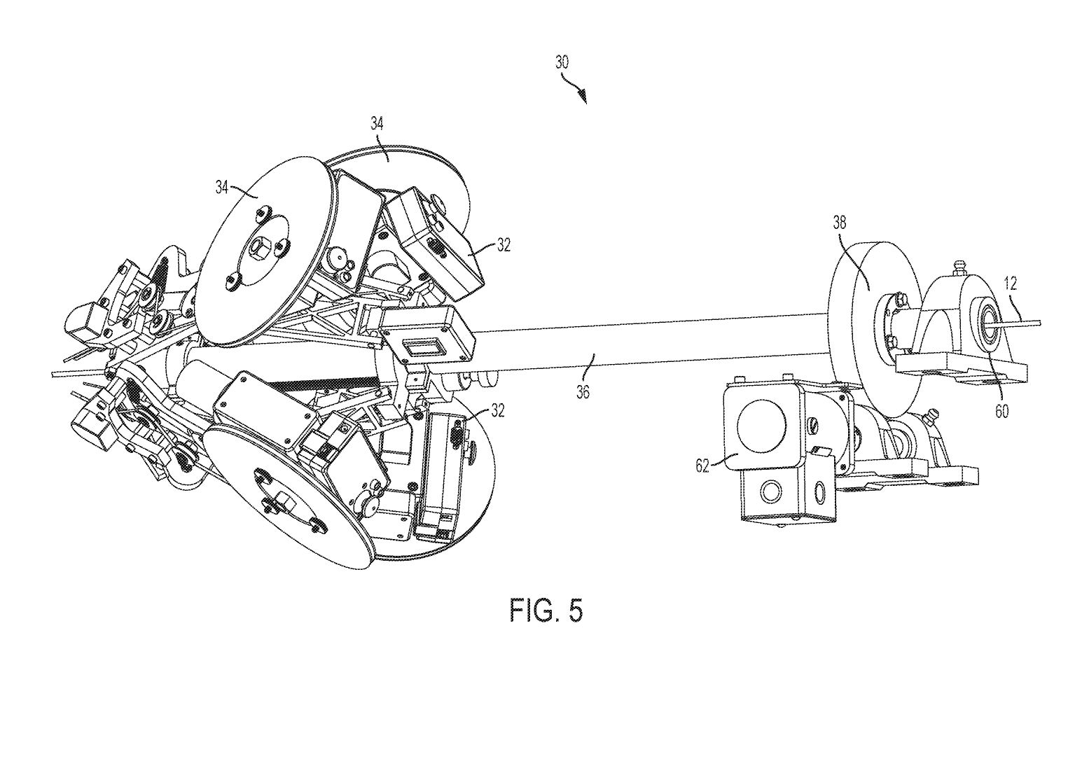

Referring still to FIG. 1, the rotation of the tapes or wires to be wound onto the cable 12 is driven by the rotation of a planetary drive shaft 36 of a planetary drive system 30. The planetary drive system 30 generally includes the rotatable planetary drive shaft 36, a gear 38, a plurality of rotatable tape spools 34 that hold (or are configured to hold) the tapes or wires to be bundled, and a tape spool holder 32 to which the plurality of tape spools 34 are coupled. These elements are described in greater detail in FIGS. 5-12. The cable machine 10 further includes a cable drive system 20 including a cable takeoff spool 22 and a cable pickup spool 42. The two spools 22, 42 may each include a drive system for driving each respective spool in a rotary motion around its axis. In particular embodiments, the spool drive system includes a worm gear 24 (visible only on the cable takeoff spool 22 in FIG. 1) and an electronic motor coupled through the worm gear 24 to the spool. The spools 22, 42 may abut or otherwise operatively connect with drive axles 44, 46 (visible only on the cable pickup spool 42 in FIG. 1) that impart a drive force to rotate the spools. The cable takeoff spool 22 and cable pickup spool 42 may be structurally similar. The spools are described in greater detail in FIGS. 2-4.

In particular embodiments, during winding of the tapes or wires on the cable, the linear cable speed of the cable 12 drives the rotation (and controls the rotational speed) of the planetary drive system 30 that holds the tape spools 34 (i.e., controls the speed of rotation of the planetary drive shaft 36 and spools 34 around the axis of the drive shaft 36 and cable 12). In some cases, the cable speed is adjusted in response to the rotational speed of the planetary drive shaft 36. In particular embodiments, the coupling between the cable speed and the planetary drive rotational speed is electronic in nature instead of mechanical. For example, the cable speed may be measured with one or more cable speed sensors 28 located on or within sensing distance of the cable. The sensor data may be provided as an input for a controller for a motor of the planetary drive system 30. Electrical sensing and control of cable speed and planetary drive rotational speed, allows for an infinite combination (or many different combinations) of cable and planetary drive rotational speeds, allowing for infinite combinations (or many different combinations) of cable thickness and winding pitches, as compared to a mechanical connection.

Referring now to FIG. 2, a portion of the cable drive system 20 is shown in greater detail. More particularly, a cable pickup spool 42 and related assembly of the cable drive system 20 is shown in FIG. 2. In particular embodiments, the cable takeoff spool 22 and cable pickup spool 42 can be structurally and functionally similar, such that the features described as part of the cable pickup spool 42 may apply as well to the cable takeoff spool 22.

In the cable machine 10, the cable tension of the cable 12 is distributed over the relatively large diameter of the spools 22, 42, distributing the load on the cable surface. The cable pickup spool 42 is mounted on a spool carriage 52 such that the spool can be moved in the direction transverse to the cable 12 to allow the cable to be wound onto the cable pickup spool 42 layer by layer, where each layer may include multiple, side-by-side windings of the cable in a common radial distance from the axis of the spool, and each layer is disposed at a different radial distance from the axis of the spool. In particular embodiments, the cable pickup spool 42 is supported so that it can be set in a fixed position (not able to move) relative to the lengthwise direction of the cable 12. The cable pickup spool 42 is driven in a rotary motion about its axis by a drive system that includes an electronic motor 56 that is coupled to the spool 42, through a gear 24 (such as, but not limited to a worm gear). The gear 24 and/or the motor 56 (or a reverse rotation lock, ratchet or other linkage connected thereto) may be set such that the gear 24 is rotational about its axis in one direction, but is self-locking and prevented from rotation in the opposite direction. In other words, the cable tension on the cable pickup spool 42 would be unable to rotate the gear 24; the gear 24 can only be rotated by the electronic motor 56. The self-locking gear 24 prevents unspooling of the cable 12 from the spool 42 when the electric motor 56 is switched off, even when the cable tension is very high. In other embodiments, other suitable linkage may be employed to operatively couple the motor 56 to the spool 42, for selectively or controlled driving of the spool 42 in a first rotary direction about its axis, while inhibiting reverse rotation of the spool in a second (opposite) rotary direction.

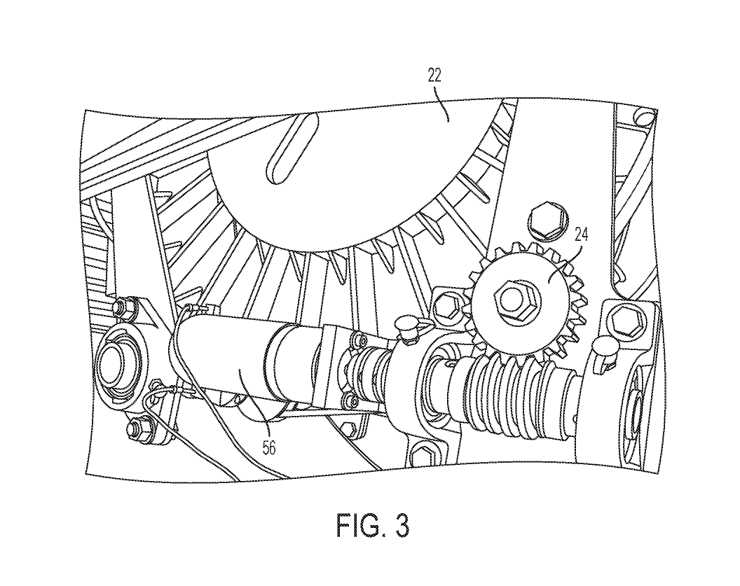

One or more additional gear boxes may be present between the motor 56 and the gear 24, or between the gear and the axle that drives the spool 42, to obtain a preferred drive ratio. Additionally, a torque limiter may be placed between the spool 42 and the gears 24, or between the motor 56 and the gears 24. The torque limiter may prevent the cable 12 from being over-tensioned by slipping when the torque exceeds a certain value. The torque limiter may be electrical or mechanical. Referring to FIG. 3, a detailed view of an example of the motor 56 and gear 24 is shown. In the embodiment of FIG. 3, the motor 56 is coupled to cause the rotation of the gear 24, which abuts (is engaged with) or otherwise coupled to the spool to cause rotational movement of the spool 42 with rotation of the drive shaft 54.

The connection between the cable pickup spool 42 and the drive axles 44, 46 may be a fixed connection in which the spool 42 rotates on the drive axles 44, 46, or may be through a drive mechanism 54 (e.g., a wheel or shaft) that is mounted on the drive axles 44, 46 and drives the spool 42 on its flange or other surface. FIG. 2 shows an example drive mechanism 54 on the drive shaft of an axle 44, with rollers driving the cable pickup spool 42 flange, causing the cable pickup spool 42 to move. In other embodiments, other suitable drive mechanisms may be employed to rotate the spool 42.

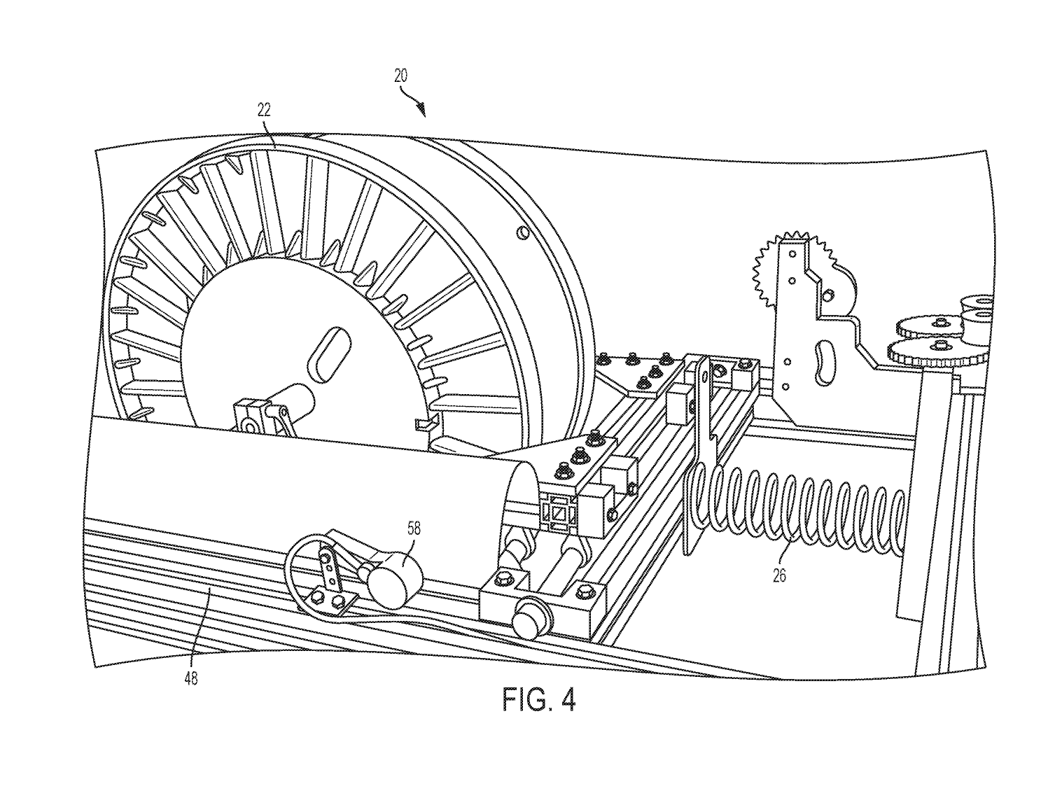

Referring now to FIG. 4, an example of the cable takeoff spool 22 is shown in greater detail. In particular embodiments, the drive mechanism of the cable takeoff spool 22 may be similar to that of the cable pickup spool 42. For example, the cable takeoff spool 22 may also include a self-locking worm gear, as described with respect to the pickup spool 42. The cable takeoff spool 22 is able to move in the transverse direction of the cable 12 to allow spooling and unspooling of the cable layer-by-layer in a controlled manner, similar to the spooling action described with respect to the pickup cable 42. In FIG. 4, the cable takeoff spool 22 is mounted in or on a carriage 48 and is able to move in the same direction as the cable 12. The carriage 52 loads a spring 26 that is mounted between and coupled to the carriage 48 and a fixed structure (such as, but not limited to the main frame of the cable machine 10, as shown in both FIG. 1 and FIG. 4). The cable tensioning spring 26 imparts a force on the carriage 52 that causes the cable 12 to remain under tension even when the cable spool motors are not activated. (The force may be in the lengthwise direction of the cable 12, and oriented to urge the takeoff spool 22 in a direction away from the pickup spool 42, i.e., toward the left in FIG. 1.) FIG. 4 shows the cable takeoff spool 22 mounted in a spring-loaded carriage 48. The cable tension may be determined by the spring constant and the displacement of the carriage 48 from its equilibrium position. In one embodiment, instead of (or in addition to) the cable takeoff spool 22, the cable pickup spool 42 may be mounted in a spring-loaded carriage, to maintain tension.

Referring generally to FIGS. 2-4, the cable speed may be controlled by the motor 56 driving the cable pickup spool 42, and is normally set to a constant rate. The cable pickup spool 42 pulls the cable 12 and loads the spring 26 between the carriage 48 of the cable takeoff spool 22 and the main frame. The self-locking gear of the cable takeoff spool 22 prevents the cable 12 from unwinding from the spool and, thus, increases or controls the cable tension to a certain set point. Once the set point has been reached, the motor driving the cable takeoff spool 22 causes the gear to turn in a first direction, to unspool the cable 12 from the cable takeoff spool 22. The speed at which the cable 12 is allowed to unspool from the cable takeoff spool 22 is controlled by the motor such that the cable tension is kept constant at its predetermined set point. The motor speed is controlled through a proportional-integral-derivative (PID) control loop on the controller. The controller may use the signal of a carriage displacement sensor 58 configured to measure the displacement of the carriage 48 and thus the spring position, such that the controller controls the motor speed dependent upon (based at least in part upon) the measured displacement of the carriage 48.

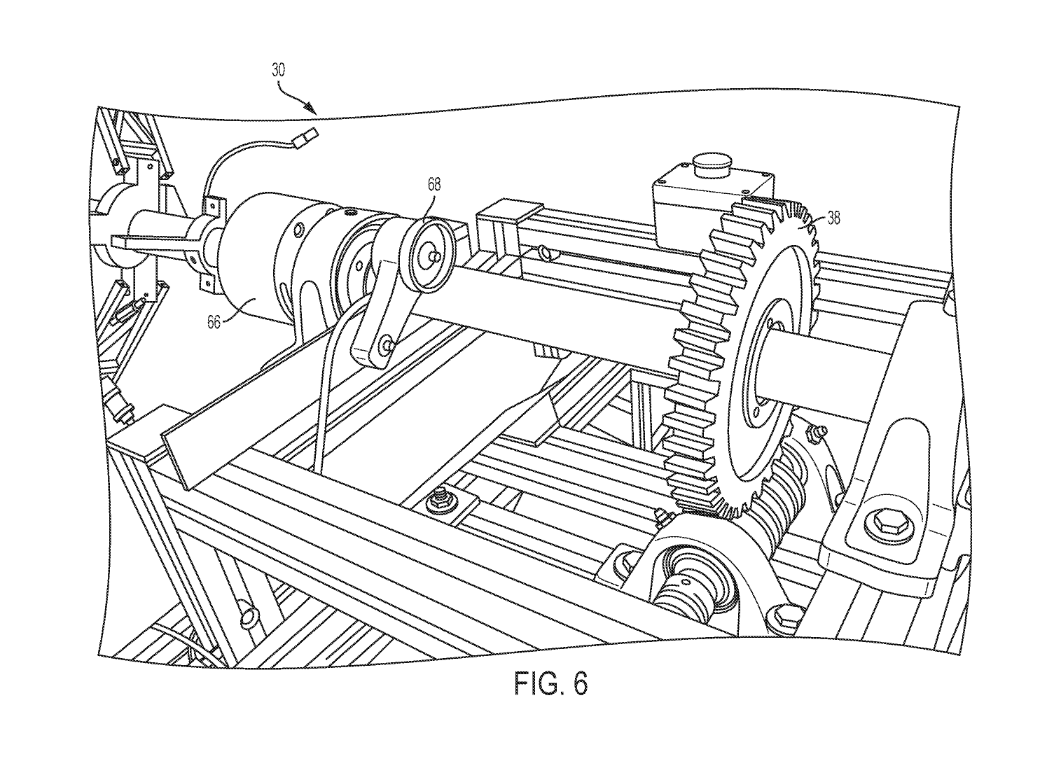

Referring generally to FIGS. 5-6, the planetary drive system 30 is shown in greater detail. The planetary drive system 30 is generally configured to cause the winding of the tapes or wires on the cable 12 as the cable is moved by the cable drive system 20. The planetary drive system 30 generally includes a planetary drive shaft 36 and a bearing 60, through which the cable 12 runs. In particular, the planetary drive shaft 36 and bearing 60 include a central passage or channel along their axial lengths, through which the cable 12 extends. The shaft 36 and bearing 60 are supported on the cable machine 10, so as to not interfere with the movement of the cable 12, as the cable 12 is fed through the central passage or channel of the shaft 36 and the bearing 60 (i.e., as the cable 12 is moved by driven rotation of one or both of the spools 22 and 42). A self-locking gear 38 (such as, but not limited to a worm gear) is connected to an electric drive motor 62 and the planetary drive shaft 36, and one or more (a plurality) of tape or wire spool holders 32 (each coupled to a single, respective tape spool 34) are connected or fixed to the planetary drive shaft 36 through a mechanical connecting mechanism. The mechanical connecting mechanism allows for adjusting an angle between the axis of the planetary drive shaft 36 (and thus the cable 12) and a plane of a tape spool 34, and locking the adjustment in place. This angle defines the winding angle of the tape or wire in the final cable 12.

The self-locking gear 38 is coupled to the motor 62, to drive the planetary drive shaft 36 in a rotary direction, prevents the shaft from rotating when the power to the motor is turned off, e.g., due to the winding tension of the tapes or wires, to prevent a loss of tension. In particular embodiments, the rotational speed of the planetary drive shaft 36 may be measured using input from a sensor (such as, but not limited to an angular displacement sensor 68 coupled to the shaft, as shown in FIG. 6). The angular displacement sensor 68 may provide, as an input for the PID controller, the angular displacement of the planetary drive shaft 36. The PID controller may receive an angular displacement metric and the cable speed from the sensor 58, and determine the rotational speed of the planetary drive shaft 36 based on the cable speed and the pitch length, or the cable length per shaft 36 rotation.

The planetary drive system 30 assembly may include a slip ring 66 composed of several electrical sliding contacts coupled to a power source. The sliding contacts may allow power to be fed from the power source, to the various motors and electronics mounted on the planetary drive shaft 36. For example, power from an external source not mounted on the planetary drive shaft 36 may be fed, through the slip ring 66, to the electronics on each spool holder 32 and tape spool 34. The slip ring 66 may couple power at different voltages to different components. The planetary drive system 30 may optionally include a damping belt or other component for improving the feedback of the electronic system driving the planetary drive shaft 36. Further, the cable machine 10 may include other component for improving the process of delivering a power supply to the various electronic components of the cable machine, or for improving the communications (e.g., sensor readings) between the various systems and components of the cable machine.

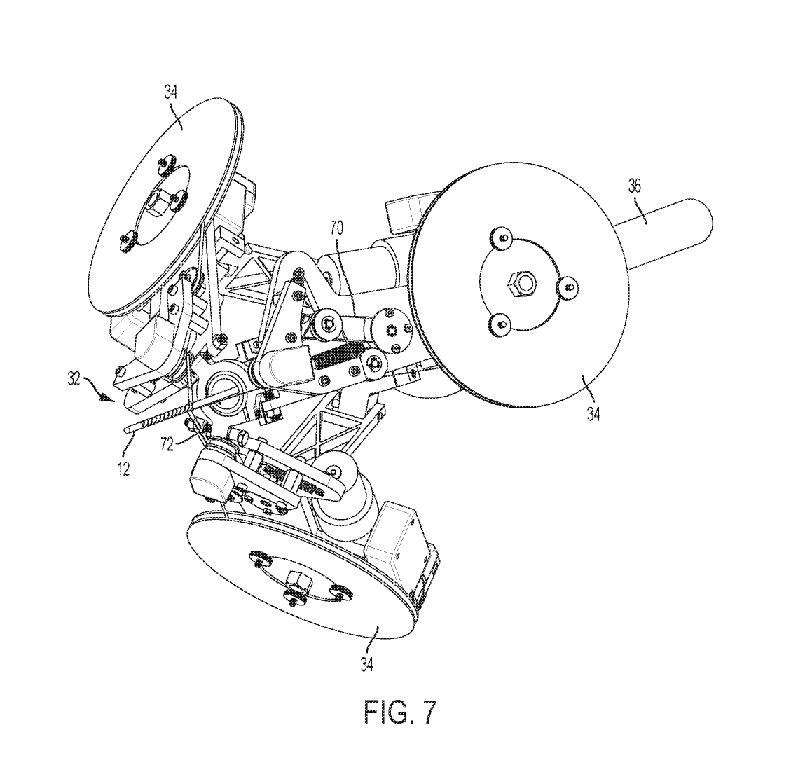

Referring generally to FIGS. 7-12, the spool holders 32 and tape spools 34 of the planetary drive system 30 are shown in greater detail, along with a tape tensioning device 70 configured to mechanically connect the spool holders 32 to the planetary drive shaft 36 and the other components of the planetary drive system. FIG. 7 illustrates three spool holders 32, each spool holder including a tape spool 34 and a tensioning device 70. In other embodiments, the systems and methods described herein may be applicable for a cabling system with one, two or more than three spools 34 (and associated spool holders 32).

The cable machine 10 may be configured to wind one layer of tapes or wires each cable pass, or a plurality of layers of tapes or wires per cable pass. Each layer may contain a single tape or wire, or a plurality of tapes or wires in parallel. For a given layer with several tapes or wires in parallel, all of the spool holders 32 may be mounted at the same winding angle on the planetary drive shaft 36.

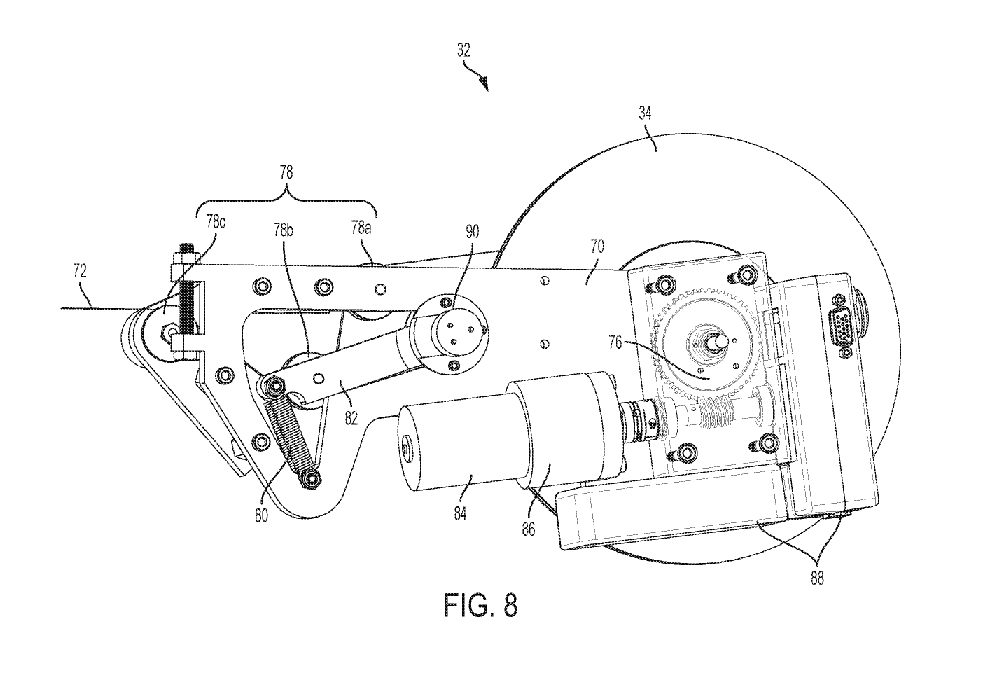

Referring to FIG. 8, an individual spool holder 32 is shown in greater detail. Each spool holder 32 includes a spool 34 with tape or wire, an electrical motor 84 to drive the rotation, a self-locking gear 76 (such as, but not limited to a work gear) connecting the motor 84 with the axle of the spool 34, and a tensioning device 70 that allows for measurement of the tape or wire tension and at the same time acts as a buffer against rapid changes in the tape or wire tension. Additionally, one or more optional gearboxes 86 may be placed between the motor 84 and the gear 76 (as shown in FIG. 8), or between the gear 76 and the spool 34. A torque limiter may also be placed in the drive train of the spool 34, either between the spool 34 and the gear 76, or between the motor 84 and the gear 76. The torque limiter may be electrical or mechanical and prevents the tape tension from exceeding a certain maximum value by limiting the torque that is transferred from the motor 84 to the spool 34.

The tensioning device 70 is shown to include a pivotal, spring-loaded arm 82 (shown coupled to spring 80) in combination with a plurality of guide reels 78. As shown in FIG. 8, the tape 72 runs from the spool 34 over one fixed guide reel 78a to the reel 78b located at an end of the spring-loaded arm 82, to another fixed guide reel 78c and finally onto the cable 12. In other embodiments, any number or configuration of reels may be included in the tensioning device 70.

The location of the various guide reels 78 is such that the tape 72 moves the spring-loaded arm 82 and tensions the spring 80 as the tape tension increases. The angular pivotal displacement of the spring-loaded arm 82, or the linear displacement of a fixed point on the spring-loaded arm 82, could be measured with one or more sensors (e.g., by an angular displacement sensor 90 located on or within sensing distance from the arm 82 as shown in FIG. 8). The sensor output can be used along with a calibration factor to make a direct determination of the tape tension. The length of the arm 82, together with the mounting location and constant of the spring 80, provide the tensioning device 70 with a buffer against sudden changes in the tape or wire tension. In other words, a certain tape or wire length needs to be cabled to allow for a certain increase in tape or wire tension when the motor driving the tape spool is deactivated.

The tape tension is increased when the planetary drive shaft 36 rotates around the cable 12 and the tape or wire 72 is wound onto the cable 12. The increase in tape or wire tension may cause the inability to rotate the spool 34 due to the self-locking worm gear 76. Only when the motor 84 is activated does the spool 34 rotate, feeding the tape or wire 72 onto the cable 12, thereby limiting or preventing an increase in tape or wire tension. The displacement of the spring-loaded arm 82 is sensed and is uses as an input for the PID controller. In the embodiment of FIG. 8, the PID controller may be located within electronic controls 88 located on the tensioning device 70, or on the shaft of the planetary drive shaft 36. The controller controls the motor 84 feeding the tape or wire 72, and is configured to maintain the tape or wire tension at a predetermined set tension value. This method of operation also allows for unwinding the tape or wire 72 from the cable 12, back onto the tape spool 34 in a controlled manner. Driving the spool 34 through a self-locking gear 76 also prevents the release of tension when the power fails, or when other faults occur. In further embodiments, the tape guide reels 78 include flanges or have another shape such that they force the tape or wire 72 into a certain direction. Alternatively, the tape guide reels 78 may have a smooth surface without a flange, allowing the tape or wire 72 to guide itself.

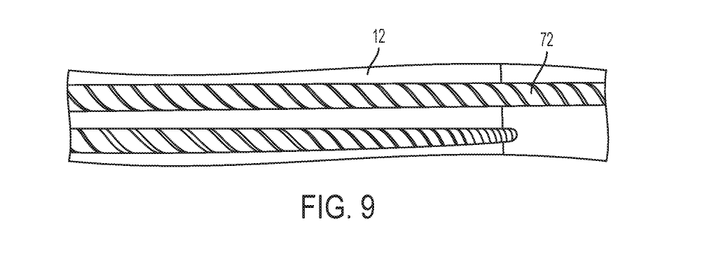

The spacing between tapes 72 in a given layer is determined by the tape width, the cable diameter, and the winding pitch. Variations in parameters such as the winding angle or tape tension between the tape or wire spool holders 32 may cause variations in gap space between neighboring tapes, although variation of the total gap space in each layer only depends on variations in the actual pitch. Adjusting tape tension between individual tensioning devices 70 for individual spool holders 32 allows for variation in gap spacing between individual tapes, and may be used to correct for variations in winding angle. FIG. 9 illustrates an example image of a CORC cable wound with the cable machine 10. A gap spacing between the taps in the outer layer and their relatively small variation over the cable length is illustrated.

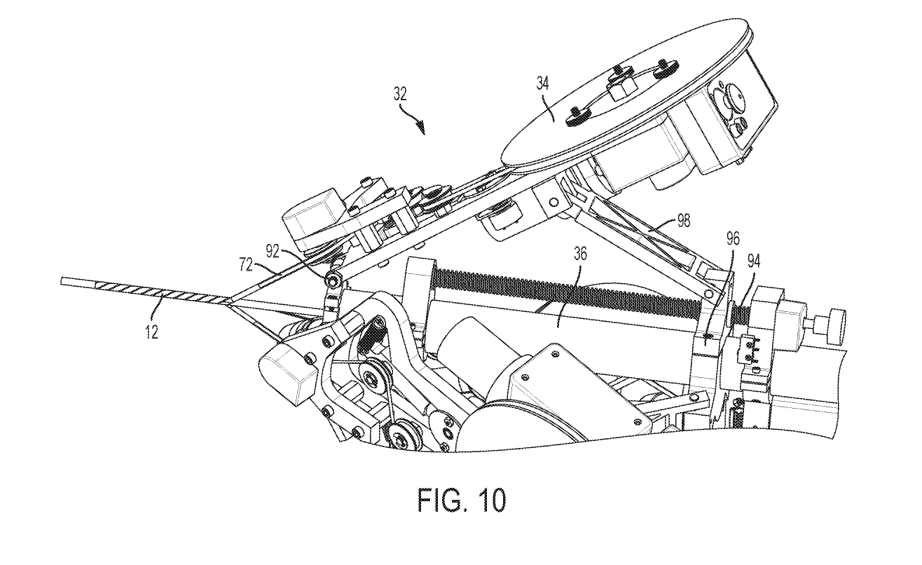

Referring now to FIGS. 10-12, adjustment of the tape spool holders 32 is shown in greater detail. The tape spool holder 32 of FIG. 10 is shown coupled to a holder arm 98 for adjusting the angle between the spool and cable. The angle between the tape or wire spools 34 and the cable 12 may be adjusted mechanically by a device such as a threaded rod 94 that moves a threaded sleeve 96 in the axial direction of the planetary drive shaft 36 (or of the cable 12). More specifically, the holder arm 98 has a first end coupled to the threaded sleeve 96 and a second end coupled to the spool 34. The threaded sleeve has a threaded opening through which the threaded rod 94 extends. In addition, the threaded sleeve extends around the circumference of the shaft 36 and is not rotatable relative to the shaft axis, but is moveable in the direction of the axial length of the shaft. In particular embodiments, multiple holder arms 98 are coupled to the sleeve 96, around the circumference of the sleeve, where each holder arm 98 has a second end that is coupled to a different respective spool 34. Rotation of the threaded rod 94 causes the sleeve 96 (and the first end of each holder arm 98 coupled thereto) to move in a direction parallel to the axial length of the shaft 36, to change the angle of the spool holder 32 (i.e., to change the angle of the tape or wire 72 relative to the cable 12). In some embodiments, there may be a slight misalignment between individual spool holders 32 that causes their angles with the cable 12 to deviate slightly. Further, there may be slight deviations between the location of the center of the tape or wire spool 34 and a fixed point on the cable 12, caused by for instance machining tolerances. Both deviations in angle or location along the cable 12 axis between the spool holders 32 might cause a variation in gap spacing between the tapes when they are wound into each layer. Such deviation could potentially be adjusted and reduced or eliminated, by changing the tension on some of the tapes, or by correcting for the deviation in angle and spool location itself.

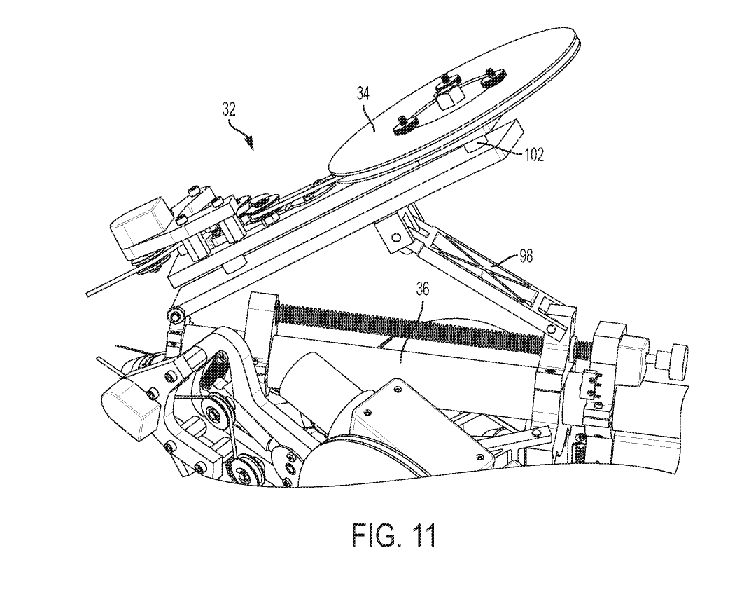

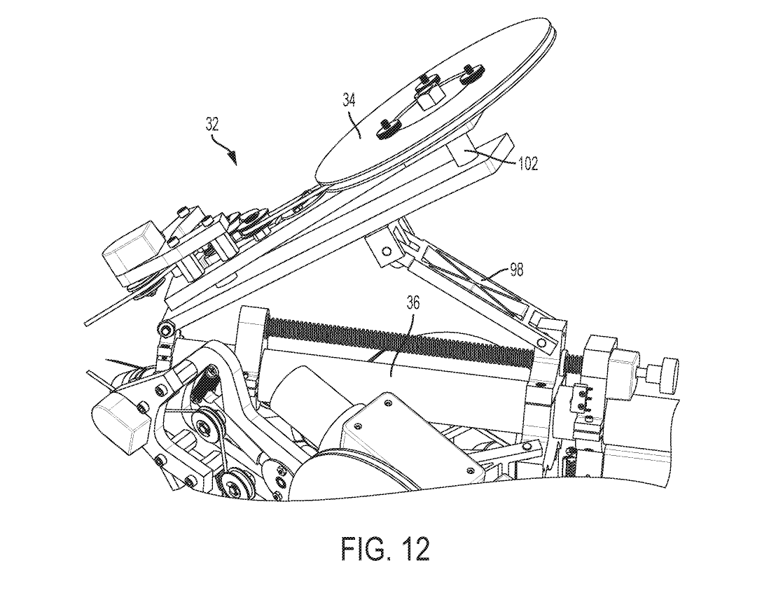

A possible way of adjusting the alignment of the tape spools 34 with respect to the cable 12 is to provide a mechanical or electrical adjustment device 102 between the base of the spool holder 32 and the plate onto which the spool is mounted. Referring to FIG. 11, an adjustment device 102 positions or adjustably moves two plates of the spool holder 32 toward or away from each other, effectively moving the tape 72 along the cable 12 axis. In further embodiments, the two plates of the spool holder may be positioned or moved in a parallel fashion (as shown in FIG. 11), or in a non-parallel fashion (as shown in FIG. 12 wherein a first adjustment device 104 is larger than a second adjustment device 106, resulting in a larger separation between plates of the spool holder than the separation provided by the second adjustment device). This effectively changes the winding angle of the tape 72. The adjustment devices 102, 104, 106 may be mechanical devices, such as one or more threaded rods threaded within threaded apertures in the plates, shims between plates, or an electrical device (such as, but not limited to a solenoid, piezoelectric device, electromagnet device, or other suitable device). Fine adjustment could be performed before the layer winding starts, or during winding with an electronic controller (processor) coupled to the electrical adjustment device and one or more sensors, in electronic feedback loop.

Many applications of superconducting magnet cables that are wound from tapes require a relatively high precision when it comes to gap spacing between tapes in each layer. In one embodiment, in-line quality control of the cabling process may be implemented by measuring the gap spacing between tapes close to the location at which the tapes are wound onto the cable. Gap spacing measurements may be performed with for instance, but not limited to, optical sensors that are either stationary or rotate around the cable in the same or opposite direction and with the same or different rotational speed as the spool holders mounted on the planetary drive. The optical sensors may measure the gap spacing between each tape and provide this information as input to a control mechanism that adjusts the tension of each individual tape as the tape is being wound, or via fine adjustment mechanism shown in FIGS. 11-12. The change in tension of one tape with respect to the other tapes that are being wound into the same layer causes a relative shift of the tape position in that layer, thus effectively changing the gap spacing. The in-line measurement of the gap spacing between the tapes in the layer being wound, along with active control of the tape tension of the individual tapes, improves the gap spacing homogeneity over the cable length, compared to a cable machine without such feedback.

A controller (electronic processor) for receiving data relating to the operation of the cable machine 10 may be implemented as part of the cabling system. Such a controller may be located locally to the cable machine 10 in any location, or may be located remotely from the cable machine 10 and receive a wired or wireless transmission from an electronic circuit of the cabling machine. The controller may receive a plurality of sensor inputs, such as a cable speed, planetary drive rotational speed, tape speed, tape tension, actual winding pitch, etc., as well as the controller output signals that control each individual motor spool holder 32. All such data may be record with a timestamp and stored in a database by the controller.

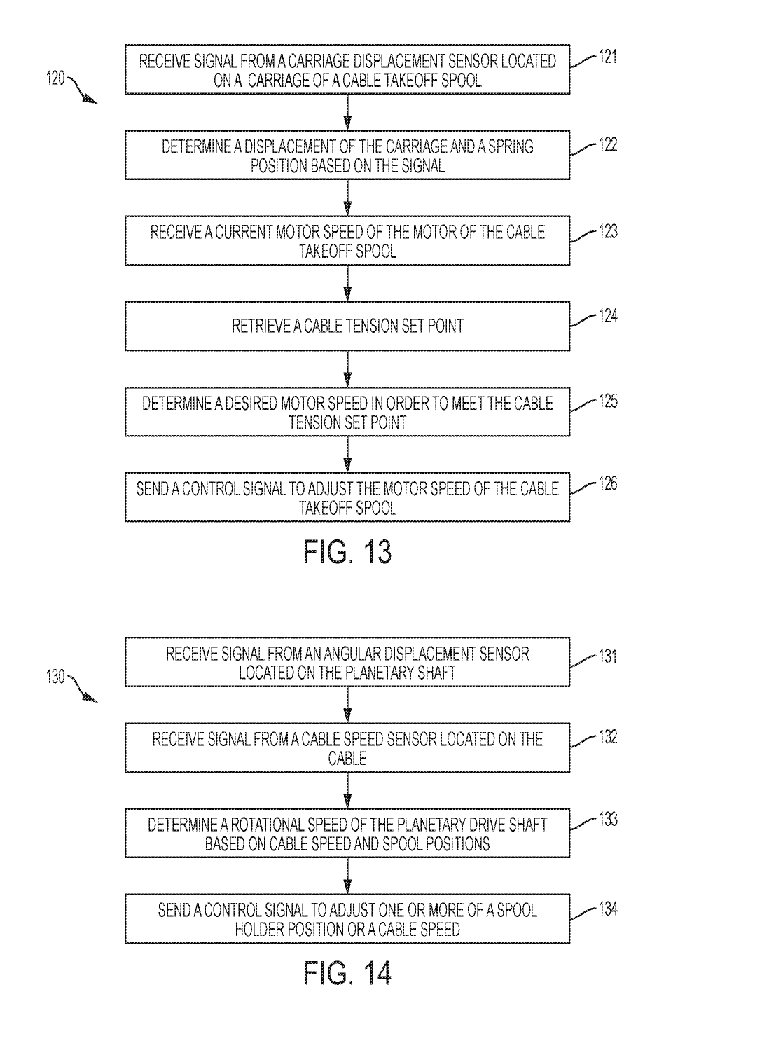

Referring to FIGS. 13-14, a flow chart of two example processes 120, 130 for cable machine operation is shown. More particularly, the processes may relate to an adjustment to one or more parameters of the cable machine, such as the positional adjustment of a tape spool holder 32, the cable speed, or the rotational speed of the planetary drive shaft 36. While the processes 120, 130 describe particular embodiments, it should be understood that similar processes may be applicable to provide additional control and features of the cable machine 10 as described in the present disclosure. The processes 120, 130 may be implementable by a local controller of the cable machine 10, located anywhere on the cable machine and configured to receive sensor readings and other data from a plurality of electronic circuity coupled to each tape spool holder and the cable takeoff and pickup spools.

The process 120 of FIG. 13 includes receiving a signal from a carriage displacement sensor located on a carriage on which a cable takeoff spool is mounted (121). The carriage displacement sensor may measure the displacement of the carriage relative to a resting position. The carriage may be displaced by a spring (e.g., cable tension spring 26 as shown in FIG. 4) during winding of a tape or wire on the cable, controlling the cable tension during the process. The process 120 further includes determining a displacement of the carriage and the spring position (122) based on the sensor data.

The process 120 further includes receiving a current motor speed of the motor of the cable takeoff spool (123). The current motor speed may be provided by a sensor or by electronic circuitry associated with the motor. The process 120 further includes retrieving a cable tension set point (124), which may be a pre-defined set point or a set point received from a remote source. The cable tension set point may define a cable tension that should be maintained by the cable machine during the winding process, in order to ensure that the tape or wire is being wound properly.

The process further includes determining a desired motor speed in order to meet the cable tension set point (125). If the desired motor speed is different from the current motor speed, the controller may send a control signal to adjust the motor speed of the cable takeoff spool (126).

The process 130 of FIG. 14 includes receiving a signal from an angular displacement sensor located on the planetary shaft (131). The angular displacement sensor may indicate the position of the various tape spools mechanically connected to the planetary shaft. The process 130 further includes receiving a signal from a cable speed sensor (132) located on the cable and configured to measure the speed of the cable (132). The cable speed sensor is located on, for example, the actual cable, as shown in FIG. 1.

The process 130 further includes determining a rotational speed of the planetary drive shaft based on the cable speed and the spool positions (133). For example, the controller may determine a pitch length (e.g., a displacement of the spools) based on the angular displacement sensor, which indicates the angle at which the tapes or wires are being wound on the cable. Using that information and the cable speed allows the controller to determine the rotational speed of the planetary drive shaft, indicating how fast the cable machine is winding tape or wire onto the cable.

The process further includes sending a control signal to adjust one or more of a spool holder position or a cable speed (134). As described in the present disclosure, the rotational speed may indicate a rotation of the planetary drive shaft, which may indicate a loss in tension during an idle motor state of the cable machine. The control signal sent by the controller may be used to adjust the position of one or more of the spool holders (e.g., to make sure the position of each spool holder is uniform, to change the winding angle of the tapes or wires, etc.).

The order or sequence of any process or method steps may be varied or re-sequenced according to alternative embodiments. Other substitutions, modifications, changes and omissions may also be made in the design, operating conditions, and arrangement of the various exemplary embodiments without departing from the scope of the present invention. In addition, sensors described herein (including, but not limited to sensors 28, 58, 68 and 90) may be optical, mechanical, electrical, magnetic or combinations thereof.

The construction and arrangement of the elements as shown in the exemplary embodiments are illustrative only. Although embodiments of the present disclosure have been described in detail, those skilled in the art who review this disclosure will readily appreciate that many modifications are possible (e.g., variations in sizes, dimensions, structures, shapes, and proportions of the various elements, values of parameters, mounting arrangements, use of materials, orientations, etc.) without materially departing from the novel teachings and advantages of the subject matter recited. For example, elements shown as integrally formed may be constructed of multiple parts or elements.

What is claimed is:

1. A cable machine system for winding conductive tapes or wires around a cable core, the system comprising:
a rotatable pickup spool for receiving and winding a cable;
a rotatable shaft having a central passage along an axial length of the rotatable shaft, through which the cable core may extend during a winding operation, the rotatable shaft being supported for rotation about an axis extending in the axial length of the rotatable shaft;
at least one conductor spool for holding a conductive tape or wire and having an axis of rotation supported for rotation about the axis of rotation of the conductor spool, each conductor spool being attached to the rotatable shaft and rotatable about the axis of the rotatable shaft with rotation of the rotatable shaft;
wherein upon the at least one conductor spool holding a conductive tape or wire and upon a cable core moving through the central passage of the rotatable shaft, the tape or wire may be extended from the conductor spool to the cable core and be wound around the cable core as the rotatable shaft is rotated about its axis.

2. A cable machine system of claim 1, wherein the at least one spool for holding a conductive tape or wire comprises a plurality of spools, each spool being attached to the rotatable shaft and rotatable about the axis of the rotatable shaft with rotation of the rotatable shaft.

3. A cable machine system of claim 2, further comprising a plurality of adjustable holders, each adjustable holder for holding a respective one of the at least one conductor spool at an angle that is adjustable, the angle of the respective one of the conductor spools defining an angle at which the conductive tape or wire meets the cable core, upon the respective one of the conductor spools holding a conductive tape or wire and upon the tape or wire extending from the conductor spool to the cable core.

4. A cable machine system of claim 1, further comprising a drive device for driving the at least one pickup spool to move the cable core through the central passage of the rotatable shaft, as the rotatable shaft is rotated.

5. A cable machine system of claim 1, further comprising at least one sensor for sensing a speed at which the cable core is moved through the central passage of the rotatable shaft.

6. A cable machine system of claim 5, further comprising a controller operatively coupled to the at least one sensor, for controlling a speed of rotation of the rotatable shaft, based at least in part on the speed sensed by the at least one sensor.

7. A cable machine system of claim 1, further comprising:
a drive device for driving the rotatable shaft for rotation about the axis of the rotatable shaft;
at least one sensor for sensing a speed at which the cable core is moved through the central passage of the rotatable shaft; and
a controller operatively coupled to the at least one sensor and the drive device, for controlling a speed of rotation of the rotatable shaft, based at least in part on the speed sensed by the at least one sensor.

8. A cable machine system of claim 1, further comprising:
a drive device for driving the at least one conductor spool about the axis of rotation of the conductor spool;
at least one sensor for sensing a speed at which the cable core is moved through the central passage of the rotatable shaft; and
a controller operatively coupled to the at least one sensor and the drive device, for controlling a speed of rotation of the conductor spool, based at least in part on the speed sensed by the at least one sensor.

9. A cable machine system of claim 1, further comprising an adjustable holder for holding the at least one conductor spool at an angle that is adjustable, the angle of the at least one conductor spool defining an angle at which the conductive tape or wire meets the cable core, upon the conductor spool holding a conductive tape or wire and upon the tape or wire extending from the conductor spool to the cable core.

10. A cable machine system of claim 1, further comprising a drive device for driving the at least one conductor spool about the axis of rotation of the conductor spool in a first direction of rotation corresponding to a direction to dispense conductive tape or wire from the conductor spool; and a rotation lock for inhibiting rotation of the conductor spool in a direction opposite to the first direction.

11. A cable machine system of claim 1, further comprising:
a rotatable takeoff spool for supplying the cable core;
a drive device for driving the takeoff spool for rotation about an axis of the takeoff spool;
a cable tension spring operatively coupled to the takeoff spool and configured to provide a force on the takeoff spool in a direction away from the pickup spool.

12. A cable machine system of claim 11, further comprising a frame to which the pickup spool, the takeoff spool and the rotatable shaft are each supported for rotation.

13. A method of operating a cable machine system for winding conductive tapes or wires around a cable core, the method comprising:
providing a rotatable pickup spool on which a cable may be wound wound;
supporting a rotatable shaft for rotation about an axis extending in the axial length of the rotatable shaft;
extending the cable through a central passage in a rotatable shaft, along the axial length of the rotatable shaft, and to the pickup spool;
holding at least one conductive tape or wire on at least one conductor spool having an axis of rotation, each conductor spool being attached to the rotatable shaft;
rotating each conductor spool about the axis of the rotatable shaft with rotation of the rotatable shaft, while the cable extends through the central passage in the rotatable shaft;
moving the cable core through the central passage of the rotatable shaft while rotating the rotatable shaft about the axis of the axis of the rotatable shaft and while the tape or wire is extended from the conductor spool to the cable core, to wind the tape or wire around the cable core.

14. A method of claim 13, wherein holding at least one conductive tape or wire comprises holding a plurality of conductive tapes or wires on a plurality of respective conductor spools, each conductor spool being attached to the rotatable shaft.

15. A method of claim 14, further comprising a plurality of adjustable holder, each adjustable holder for holding a respective one of the at least one conductor spool at an angle that is adjustable, the angle of the respective one of the conductor spools defining an angle at which the conductive tape or wire meets the cable core, upon the respective one of the conductor spools holding a conductive tape or wire and upon the tape or wire extending from the conductor spool to the cable core.

16. A method of claim 13, further comprising driving the at least one pickup spool to move the cable core through the central passage of the rotatable shaft, as the rotatable shaft is rotated.

17. A method of claim 13, further comprising sensing, with a sensor, a speed at which the cable core is moved through the central passage of the rotatable shaft; and controlling a speed of rotation of the rotatable shaft, based at least in part on the speed sensed by the at least one sensor.

18. A method of claim 13, further comprising:
driving the rotatable shaft for rotation about the axis of the rotatable shaft;
sensing, with a sensor, a speed at which the cable core is moved through the central passage of the rotatable shaft; and
controlling a speed of rotation of the rotatable shaft, based at least in part on the speed sensed by the at least one sensor.

19. A method of claim 13, further comprising:
driving the at least one conductor spool about the axis of rotation of the conductor spool;
sensing, with a sensor, a speed at which the cable core is moved through the central passage of the rotatable shaft; and
controlling a speed of rotation of the conductor spool, based at least in part on the speed sensed by the at least one sensor.

20. A method of making a cable machine system for winding conductive tapes or wires around a cable core, the method comprising:
supporting a pickup spool for rotation, for receiving and winding a cable;
supporting a rotatable shaft for rotation about an axis extending along an axial length of the rotatable shaft, the rotatable shaft having a central passage along the axial length, through which the cable core may extend during a winding operation;
supporting at least one conductor spool for rotation about the axis of rotation of the conductor spool, the conductor spool for holding a conductive tape or wire, each conductor spool being attached to the rotatable shaft;
wherein upon the at least one conductor spool holding a conductive tape or wire and upon a cable core moving through the central passage of the rotatable shaft, the tape or wire may be extended from the conductor spool to the cable core and be wound around the cable core as the rotatable shaft is rotated about its axis.
